(19) United States
(12) Patent Application Publication
(10) Pub. No.: US 2014/0044496 A1
(43) Pub. Date: Feb. 13, 2014

(54) CUTTING INSERT AND CLAMPING ELEMENT FOR A CUTTING TOOL

(71) Applicants: Sharath Shankaregowda, Bangalore (IN); Shreelakshmi Krishnegowda, Bangalore (IN); K. Visweswara Rao, Pune (IN); Prem Kumar, Bangalore (IN)

(72) Inventors: Sharath Shankaregowda, Bangalore (IN); Shreelakshmi Krishnegowda, Bangalore (IN); K. Visweswara Rao, Pune (IN); Prem Kumar, Bangalore (IN)

(73) Assignee: KENNAMETAL INC., Latrobe, PA (US)

(21) Appl. No.: 13/958,741

(22) Filed: Aug. 5, 2013

(30) Foreign Application Priority Data
Aug. 7, 2012 (IN) 3247/CHE/2012

(51) Int. Cl. B23C 5/22; B23C 5/20

(52) U.S. Cl. CPC B23C 5/2247; B23C 5/205; B23C 5/207
USPC 407/40; 407/114; 407/107

(57) ABSTRACT

A cutting insert and a clamping element for clamping the cutting insert in a pocket of a cutting tool. The cutting insert includes a polygonal body, a top surface, a bottom surface, a plurality of side surfaces, a rake surface extending inwardly from a cutting edge, and a plurality of seating surfaces adjacent the rake surface that are separated by a groove. The clamping element includes a rail member protruding from a bottom surface and extending at least partially from a side surface. The groove of the cutting insert is capable of receiving the rail member of the clamping element for clamping the cutting insert in the pocket of the cutting tool.

### BACKGROUND OF THE INVENTION

1. Field of the Invention

The invention pertains to the field of indexable cutting inserts. More particularly, the invention pertains to an indexable cutting insert having at least one groove on a top surface and/or a bottom surface for cooperating with a rail member on a planar face of a clamping element to clamping the cutting insert in a pocket of a cutting tool.

2. Description of Related Art

Conventional cutting tools with replaceable inserts use various means for mounting the inserts to the tool body. Some known inserts are mounted with a locking screw passed through the center of the insert and secured in a hole in the insert seating surface. The axis of the hole may be perpendicular to the insert and the insert seating surface or the axis of the hole may be skewed.

One known method of clamping a polygonal-shaped cutting insert in a pocket of a cutting tool is by means of a wedge having a planar contact face that engages a planar seating area of the cutting insert. However, the insert can not be easily indexed and the insert has a tendency to fly out of the pocket at higher cutting speeds, thereby increasing cycle times and associated costs.

### SUMMARY OF THE INVENTION

The problem of clamping a polygonal-shaped cutting insert in a pocket of a cutting tool is solved by providing a plurality of grooves in the top and/or bottom surface of the cutting insert and a rail member on a clamping element that engages at least one of the grooves to securely hold the insert in place.

In one aspect of the invention, an indexable cutting insert comprises a polygonal body that is symmetric about a central axis C_{L}, and including a top surface, a bottom surface and a plurality of side surfaces; a plurality of cutting edges formed at an intersection between one of the top surface and the bottom surface and each side surface; a corner separating each cutting edge from an adjacent cutting edge; a rake surface extending inwardly from each cutting edge; and a plurality of seating surfaces adjacent the rake surface, each seating surface separated by a groove, wherein the groove is capable of receiving a rail member of a clamping element for clamping the cutting insert in a pocket of a cutting tool.

In another aspect of the invention, a cutting insert and a clamping element assembly comprises an indexable cutting insert comprising a polygonal body that is symmetric about a central axis C_{L}, and including a top surface, a bottom surface and a plurality of side surfaces; a plurality of cutting edges formed at an intersection between one of the top surface and the bottom surface and each side surface; a corner separating each cutting edge from an adjacent cutting edge; a rake surface extending inwardly from each cutting edge; and a plurality of seating surfaces adjacent the rake surface, each seating surface separated by a groove; and a clamping element comprising an arcuate-shaped top surface, a bottom surface, and a pair of opposing side surfaces; and a rail member protruding from the bottom surface and extending at least partially from one of the side surfaces toward the other one of the side surfaces, wherein the groove is capable of receiving the rail member of the clamping element for clamping the cutting insert in a pocket of a cutting tool.

In another aspect of the invention, a cutting tool comprises a tool body including a cutting end with a plurality of circumferentially-spaced pockets, and a mounting end opposite the cutting end, each pocket capable of receiving a cutting insert and clamping element assembly, the cutting insert and clamping element assembly comprising an indexable cutting insert comprising a polygonal body that is symmetric about a central axis C_{L}, and including a top surface, a bottom surface and a plurality of side surfaces; a plurality of cutting edges formed at an intersection between one of the top surface and the bottom surface and each side surface; a corner separating each cutting edge from an adjacent cutting edge; a rake surface extending inwardly from each cutting edge; and a plurality of seating surfaces adjacent the rake surface, each seating surface separated by a groove; and a clamping element comprising an arcuate-shaped top surface, a bottom surface, and a pair of opposing side surfaces; and a rail member protruding from the bottom surface and extending at least partially from one of the side surfaces toward the other one of the side surfaces, wherein the groove is capable of receiving the rail member of the clamping element for clamping the cutting insert in a pocket of a cutting tool.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is an isometric view of a cutting tool with a cutting insert and clamping element assembly in accordance with an embodiment of the invention;

FIG. 2 is an isometric view of a cutting insert and clamping element assembly according to an embodiment of the invention;

FIG. 3 is an isometric view of a cutting insert according to an embodiment of the invention;

FIGS. 4(a) and 4(b) are isometric views of a clamping element according to an embodiment of the invention; and

FIG. 5 is a front view of the clamping element according to an embodiment of the invention.

### DETAILED DESCRIPTION OF THE INVENTION

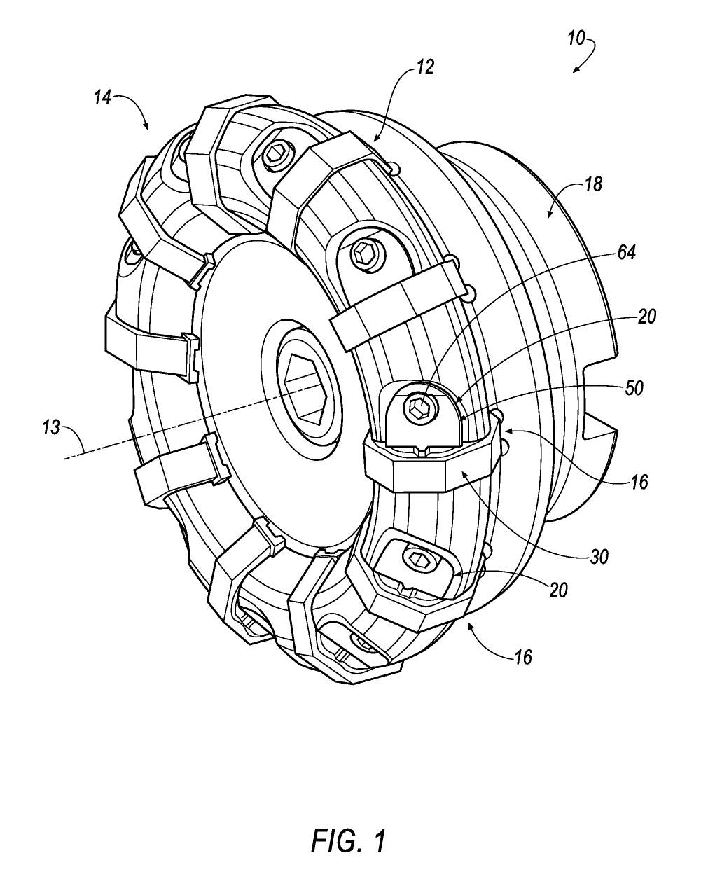

Referring now to FIG. 1, a cutting tool 10, for example, a milling cutter, is shown according to an embodiment of the invention. The milling cutter 10 comprises a tool body 12 including a cutting end 14 with a plurality of circumferentially-spaced pockets 16, and a mounting end 18 opposite the cutting end 14. The tool body 12 is designed to be rotatably driven about a central longitudinal axis 13. In the illustrated embodiment, the milling cutter 10 includes a total of ten (10) pockets 16. However, it will be appreciated that the invention is not limited by the number of pockets 16, and that the invention can be practiced with any desirable number of pockets that provide the desired cutting capabilities. Each of the pockets 16 is capable of receiving a cutting insert and clamping element assembly, shown generally at 20.

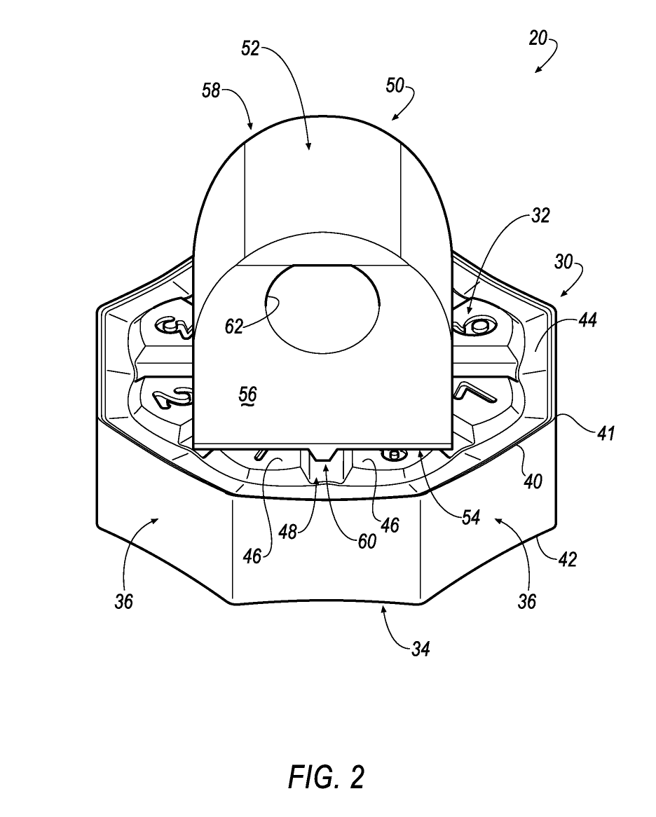

Referring now to FIGS. 2-5, the cutting insert and clamping element assembly 20 comprises an indexable cutting insert, shown generally at 30, and a clamping element, shown generally at 50.

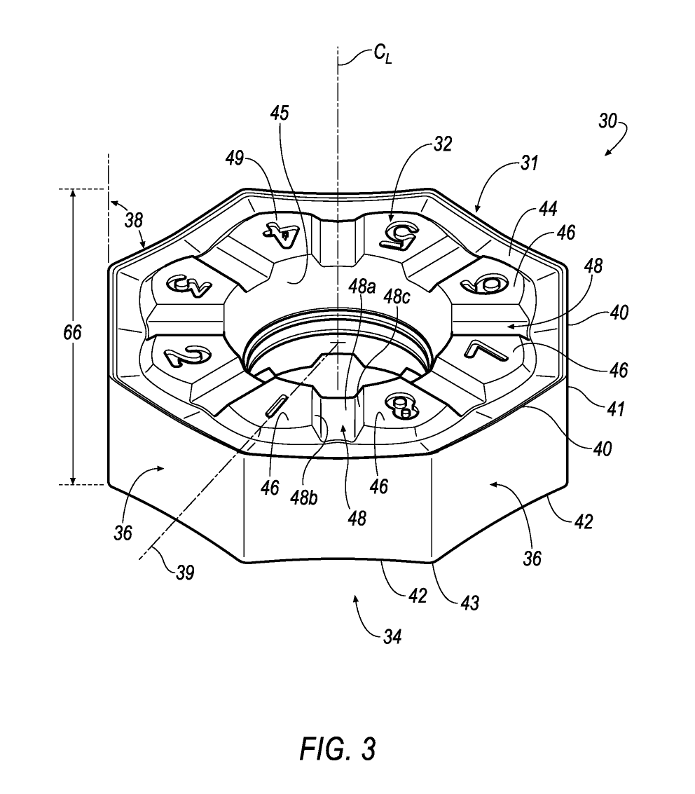

As shown in FIGS. 2 and 3, the cutting insert 30 has a polygonal body 31 of wear-resistant material. Although other geometric shapes are possible, the cutting insert 30 is of a generally octagonal shape that is symmetric about a central axis C_{L}, and includes a top surface 32, a bottom surface 34 and a plurality of side surfaces 36. However, it will be appreciated that the invention is not limited by the geometric shape of the cutting insert 30, and that the invention can be practiced with any desirable geometric shape, such as triangular, rectangular, and the like. As shown in FIG. 3, each side surface 36 has an angle 38 of approximately forty-five (45) degrees with respect to an adjacent side surface 36. Because the cutting insert 30 is symmetric about all three axes (x-, y-, z-), only the top surface 32 will be described in detail herein for brevity. However, it will be appreciated that any discussion of the top surface 32 applies to the bottom surface 34.

In the illustrated embodiment, each side surface 36 is substantially perpendicular to both the top and bottom surfaces 32, 34. In other words, the top and bottom surfaces 32, 34 are substantially parallel to each other and perpendicular to the side surfaces 36. That is, the side surfaces 36 have a facet clearance angle of zero (0) degrees. Thus, both the top and bottom surfaces 32, 34 of the cutting insert 30 can be presented to the workpiece (not shown). The side surfaces 36 engage the pocket 16 when the cutting insert and clamping element assembly 20 is mounted in the tool body 12 during cutting operations. Preferably, one of the top and bottom surfaces 32, 34 and at least two side surfaces 36 should engage the tool body 12 when the insert 30 is properly indexed in the tool body 12.

The cutting insert 30 includes a plurality of cutting edges 40 formed at the intersection between the top surface 32 and each side surface 36. A corner 41 separates each cutting edge 40 from an adjacent cutting edge 40. Similarly, the cutting insert 30 includes a plurality of cutting edges 42 formed at the intersection between the bottom surface 34 and each side side surface 36. A corner 43 separates each cutting edge 42 from an adjacent cutting edge 42. Preferably, each corner 41, 43 has a radius in the range of approximately 0.5 to 3.0 mm. However, the invention can be practiced with any desirable corner radius. It will be appreciated that each of the cutting edges 40, 42 can be indexed into an active position and effectively utilized in the milling cutter 10. Thus, the cutting insert 30 of the invention can be indexed sixteen (16) times, unlike conventional rectangular or square cutting inserts. It will be appreciated that the number of cutting edges 40 and the number of times that the cutting insert 30 can be indexed depends on the geometric shape of the cutting insert 30. In general, the number of times the cutting insert 30 of the invention can be indexed is equal to the total number of cutting edges 40. For example, a pentagon shaped cutting insert having a total of ten (10) cutting edges can be indexed ten (10) times.

The top surface 32 (and also the bottom surface 34) includes a rake surface 44 that may be substantially planar and extends inwardly and downwardly from the cutting edge 40, 42. The rake surface 44 form a flow pattern for efficient chip ejection. The top surface 32 (and bottom surface 34) also includes a plurality of raised polygonal-shaped seating surfaces 46 separated by grooves 48. The seating surfaces 46 can be any desirable shape. In the illustrated embodiment, the seating surfaces 46 are generally pentagonal in shape in which two sides are bisected by a plane 39 extending from the central axis, C_{L}, and passing through the corner 41 of the cutting insert 30. The seating surfaces 46 are generally planar and identical to each other. The seating surfaces 46 may be substantially coplanar with the cutting edges 40, or alternatively project above the cutting edges 40 by a height that is preferably in the range of about 0.05 mm to about 1.00 mm. The seating surfaces 46 serve as an insert support-seating surface when the cutting insert 30 is positioned in the milling cutter 10. One or more of the seating surfaces 46 may include indicia 49 that aid in indexing the cutting insert 30 in the milling cutter 10 by identifying the cutting edge 40, 42 that is being presented to the workpiece (not shown) during a cutting operation.

In the illustrated embodiment, there is a one-to-one correlation between the number of side surfaces 36 and the number of seating surfaces 46 and the number of grooves 48. Thus, the octagon cutting insert 30 has eight side surfaces 36, eight seating surfaces 46 and eight grooves 48. It will be appreciated that the invention is not limited by the number of side surfaces 36, seating surfaces 46 and grooves 48. In one example, the principles of the invention can be practiced with a cutting insert with six side surfaces, six seating surfaces and six grooves. In another example, the principles of the invention can be practiced with a cutting insert with four side surfaces, four seating surfaces and four grooves. It is contemplated that any number of side surfaces, seating surfaces and grooves are within the scope of the invention.

Each groove 48 comprises a substantially planar bottom wall 48a and a pair of substantially planar side walls 48b, 48c. In the illustrated embodiment, the side walls 48b, 48c are angled with respect to the bottom wall 48a, rather than perpendicular to the bottom wall 48a. However, it will be appreciated that the profile of the groove 48 can be any desired profile, so long as the profile of the groove 48 is complementary in shape to the profile of the rail member 60 on the bottom surface 54 of the clamping element 50.

The cutting insert 30 may also include a central bore 45 extending entirely through the cutting insert 30 from the top surface 32 to the bottom surface 34 for mounting the cutting insert 30 to a cutting tool using a mounting screw (not shown). In the invention, the central bore 45 may be omitted because the cutting insert 30 is mounted to the tool body 12 using the clamping element 50 of the invention. In the illustrated embodiment, the grooves 48 extend radially outward from the central bore 45 to the rake surface 44. In an alternate embodiment in which the central bore 45 is omitted, the grooves 48 may extend entirely between the rake surface 44.

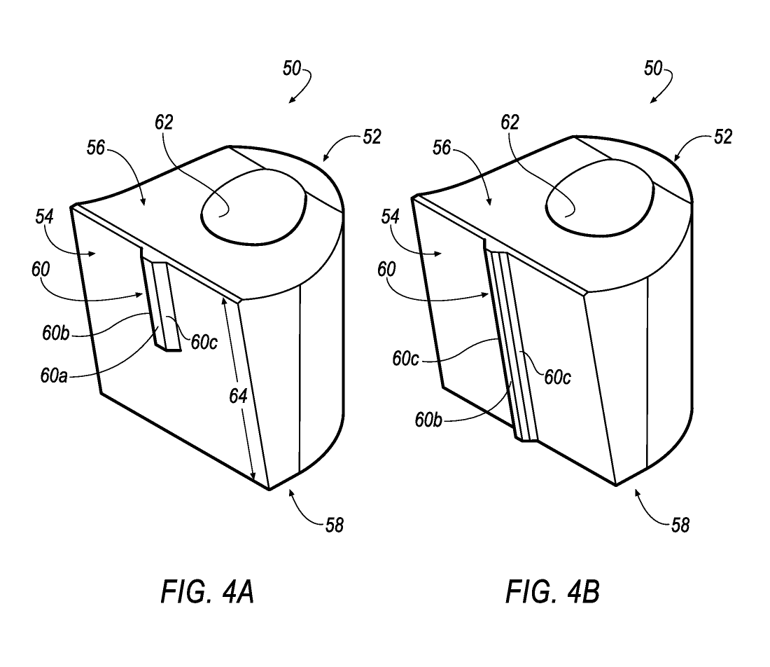

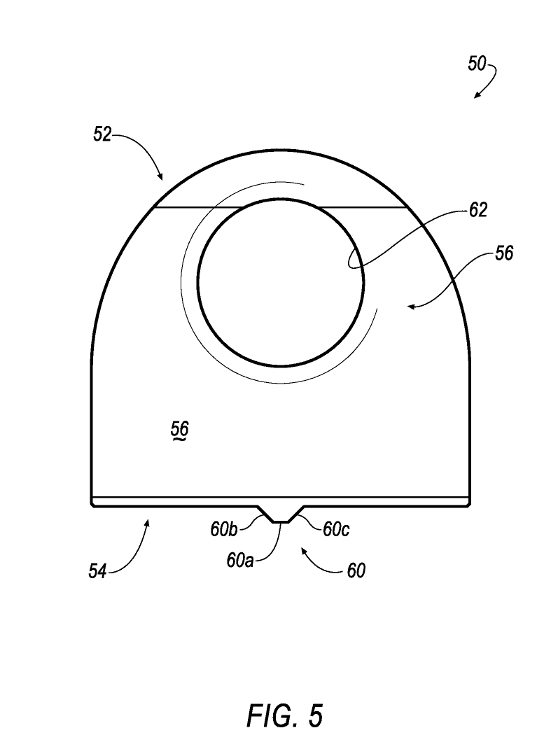

Referring now to FIGS. 4 and 5, the clamping element 50 includes an arcuate-shaped top surface 52, a planar bottom surface 54, and a pair of opposing side surfaces 56, 58 (only side surface 56 can be clearly seen in FIGS. 4 and 5).

In one aspect of the invention, the bottom surface 54 includes a rail member 60 that protrudes from the bottom surface 54 and extends at least partially from the side surface 56 toward the side surface 58, as shown in FIG. 4(a). In another embodiment, the rail member 60 extends entirely between the side surfaces 56, 58, as shown in FIG. 4(b). The length of the rail member 60 depends on the clamping force and clearance required for assembly in the tool body 12.

As shown in FIG. 5, the rail member 60 comprises a substantially planar top wall 60a and a pair of substantially planar side walls 60b, 60c. In the illustrated embodiment, the side walls 60b, 60c are angled with respect to the top wall 60a, rather than perpendicular to the top wall 60a. However, it will be appreciated that the profile of the rail member 60 can be any desired profile, so long as the profile of the rail member 60 is complementary in shape to the profile of the groove 48 on the top surface 32 of the cutting insert 30. It is possible that the rail member 60 can have a rounded profile shape and the groove 48 to have a different profile shape, such as the profile in FIG. 3, so long as the different profile shapes are capable of securely holding the cutting insert 30 in the pocket 16 of the tool body 12.

The clamping element 50 also includes a bore 62 extending from the side surface 56 to the side surface 58 for receiving a clamping screw 64 (FIG. 1) to mount the cutting insert and clamping element assembly 20 to the tool body 12 of the milling cutter 10.

Referring back to FIG. 2, the rail member 60 of the clamping element 50 sits in the groove 48 of the cutting insert 30, while the planar bottom surface 54 of the clamping element 50 engages at least two of the planar seating surfaces 46 of the cutting insert 30 when the cutting insert and clamping element assembly 20 is properly assembled. In this manner, the rail member 60 provides the necessary resistance for the movement of the cutting insert 30 in the pocket 16. It is possible that the planar bottom surface 54 of the clamping element 50 to partially engage all of the planar seating surfaces 46 of the cutting insert 30.

It is noted that the distance 64 (FIG. 4(a)) between the opposing side surfaces 56, 58 of the clamping element 50 is smaller than the distance 66 (FIG. 3) between the opposing side surfaces 36 of the cutting insert 30. In this manner, the cutting edges 40, 42 of the cutting insert 30 will be presented to the workpiece (not shown) when the cutting insert and clamping element assembly 20 is mounted in the tool body 12, as shown in FIG. 1.

For the purposes of this discussion, a cutting insert having a geometry identified as an octagon is presented. However, it should be realized that the configuration of this invention should not be limited to a square and that other geometric shapes may be substituted, for example, a square, an eighty (80) degree diamond (which has two 80 degree corners and two 100 degree corners), a fifty-five (55) degree diamond (which has two 55 degree corners and two 125 degree corners), a triangle or a trigon, and the like.

Indexable inserts of interest herein have front and back surfaces of polygonal shape joined by side edges. At least portions of the intersections of the side edge surfaces with the polygonal surfaces define line edges of the insert and at least portions of the intersections of sequential side edge surfaces define corner edges of the insert. Line edges may be linear or non-linear; corner edges may be round, truncated or other geometries.

As described above, an indexable cutting insert has at least one groove or slot on a top surface and/or a bottom surface for cooperating with a rail member on a planar face of a clamping element to provide resistance for the movement of the cutting insert when mounted in an insert pocket of a tool holder. The cutting insert and clamping element assembly 20 aids in easy indexing of the cutting insert 30 in the tool body 12. In addition, the cutting insert and clamping element assembly 20 prevents the cutting insert 30 from becoming dislodged from the pocket 16 during high speed cutting operations, thereby enabling lesser cycle times.

The patents and publications referred to herein are hereby incorporated by reference.

Having described presently preferred embodiments the invention may be otherwise embodied within the scope of the appended claims.

1. An indexable cutting insert, comprising:
a polygonal body that is symmetric about a central axis C_{L}, and including a top surface, a bottom surface and a plurality of side surfaces;
a plurality of cutting edges formed at an intersection between one of the top surface and the bottom surface and each side surface;
a corner separating each cutting edge from an adjacent cutting edge;
a rake surface extending inwardly from each cutting edge; and
a plurality of seating surfaces adjacent the rake surface, each seating surface separated by a groove,
wherein the groove is capable of receiving a rail member of a clamping element for clamping the cutting insert in a pocket of a cutting tool.

2. The cutting insert according to claim 1, wherein the groove includes a bottom wall and a pair of side walls.

3. The cutting insert according to claim 2, wherein the side walls are angled with respect to the bottom wall.

4. The cutting insert according to claim 1, wherein the groove is complementary in shape with the rail member.

5. The cutting insert according to claim 1, wherein the seating surfaces are coplanar with the plurality of cutting edges.

6. The cutting insert according to claim 1, wherein the seating surfaces project above the plurality of cutting edges.

7. The cutting insert according to claim 1, wherein the seating surfaces are polygonal in shape.

8. The cutting insert according to claim 1, further comprising a central bore extending through the cutting insert from the top surface to the bottom surface.

9. The cutting insert according to claim 8, wherein the groove extends radially outward from the central bore to the rake surface.

10. A cutting insert and clamping element assembly, comprising:
a cutting insert comprising:
a polygonal body that is symmetric about a central axis C_{L}, and including a top surface, a bottom surface and a plurality of side surfaces;
a plurality of cutting edges formed at an intersection between one of the top surface and the bottom surface and each side surface;
a corner separating each cutting edge from an adjacent cutting edge;
a rake surface extending inwardly from each cutting edge; and
a plurality of seating surfaces adjacent the rake surface, each seating surface separated by a groove; and
a clamping element comprising:
an arcuate-shaped top surface, a bottom surface, and a pair of opposing side surfaces; and
a rail member protruding from the bottom surface and extending at least partially from one of the side surfaces toward the other one of the side surfaces,
wherein the groove of the cutting insert is capable of receiving the rail member of the clamping element for clamping the cutting insert in a pocket of a cutting tool.

11. A cutting tool, comprising:
a tool body including a cutting end with a plurality of circumferentially-spaced pockets, and a mounting end opposite the cutting end, each pocket capable of receiving a cutting insert and clamping element assembly, the cutting insert and clamping element assembly comprising:
a cutting insert comprising:
a polygonal body that is symmetric about a central axis C_{L}, and including a top surface, a bottom surface and a plurality of side surfaces;
a plurality of cutting edges formed at an intersection between one of the top surface and the bottom surface and each side surface;
a corner separating each cutting edge from an adjacent cutting edge;
a rake surface extending inwardly from each cutting edge; and
a plurality of seating surfaces adjacent the rake surface, each seating surface separated by a groove; and
a clamping element comprising:
an arcuate-shaped top surface, a bottom surface, and a pair of opposing side surfaces; and
a rail member protruding from the bottom surface and extending at least partially from one of the side surfaces toward the other one of the side surfaces,
wherein the groove of the cutting insert is capable of receiving the rail member of the clamping element for clamping the cutting insert in a pocket of a cutting tool.
